(19) United States
(12) Patent Application Publication
(10) Pub. No.: US 2025/0061360 A1
(43) Pub. Date: Feb. 20, 2025

(54) QUANTUM ORACLE DECOMPOSITION FOR SIMULATING QUANTUM COMPUTING SYSTEMS AND APPLICATIONS

(71) Applicant: Nvidia Corporation, Santa Clara, CA (US)

(72) Inventors: Fereshte MOZAFARI GHORABA, Zurich (CH); Yang Gao, Santa Clara, CA (US); Yao-Lung Fang, Livingston, NJ (US)

(21) Appl. No.: 18/452,364

(22) Filed: Aug. 18, 2023

(51) Int. Cl. G06N 10/20

(52) U.S. Cl. CPC G06N 10/20

(57) ABSTRACT

In various examples, systems and methods for decomposition of quantum oracles for simulating quantum circuits are provided. A simulation platform may receive as input a representation of a quantum circuit that comprises decomposable Boolean functions that define a quantum oracle and convert a Boolean representation of the quantum oracle to a set of Boolean functions. The Boolean functions may be used to create an oracle tensor network (e.g., a MPO sub-tensor network) comprising an exact representation of the Boolean representation of the quantum oracle. The oracle tensor network representation may be incorporated into a tensor network representation of the quantum circuit and passed to the simulation platform in order to simulate the quantum circuit.

### BACKGROUND

Quantum circuits are a tool used in quantum computing to represent a sequence of quantum operations. The two primary components of quantum circuits are qubits and quantum logical gates, often referred to as “gates.” Conventionally, the gates are sometimes represented graphically using horizontal lines and various symbols on a grid-like layout. The quantum states of all qubits can be encapsulated by a state vector at any point along the horizontal line. The quantum logic gates positioned on this axis represent quantum operations performed with or on a subset of qubits, thus evolving the quantum states before a final measurement is performed.

In classical computing, when complex circuitry—such as a graphics processing unit (GPU) or central processing unit (CPU)—is under development, portions of the circuitry may be simulated on a simulation computing platform so the circuit designer can better understand how different design decisions can influence circuit performance. Similarly, designers of quantum computing systems and circuits leverage emulation of quantum computers on simulation computing platforms in order to test different design options to develop better quantum computers and more effective algorithms. When a simulation of a quantum system is run on a classical computer platform, the classical computer platform is essentially executing emulations of quantum processes. While the quantum circuit represents the expression of an algorithm in an exponential quantum space, the implications of that quantum circuit can presently be explored on a classical computer more efficiently than on a quantum computer, because in the quantum space, the depth of the quantum circuits (e.g., in terms of sequential layers of gates encountered while traversing the circuit) make executing these circuits unapproachable with quantum computers today.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present disclosure relate to decomposition of quantum oracles for simulating quantum computing systems and applications. Systems and methods are disclosed that provide for efficient simulation of quantum circuits, such as quantum oracles, using tensor network simulation on chains of small Boolean function-based tensor objects (which may be referred to herein simply as “tensors”).

In contrast to existing technologies, with one or more of the embodiments of this disclosure, an exact tensor network representation—such as (for example and without limitation) a matrix product operator (“MPO”) tensor network representation—for a family of quantum oracles that define a concatenated Boolean function may be expressed as a chain of tensors that each comprise easily computable decomposed Boolean logic operations. The resulting tensor network representation, comprising a chain of small Boolean function-based tensors, may be more efficiently contracted.

For example, in some embodiments, a simulation platform may receive as input a quantum circuit that comprises decomposable Boolean functions which define a quantum oracle, O. The simulation may convert the quantum circuit to a tensor network representation for simulation. In this process, the quantum oracle may be decomposed into a plurality of Boolean tensors while one or more other gates are directly translated into corresponding tensors. The decomposition of the quantum oracle is based on the two-variable Boolean functions encoded in the quantum oracle. The resulting Boolean tensors adopt a linear chain geometry (e.g., a MPO sub-tensor network), which, along with the other standard gate tensors, may form a full tensor network for simulation.

### BRIEF DESCRIPTION OF THE DRAWINGS

The present systems and methods for Boolean function-based decomposition of quantum oracles for tensor network simulation are described in detail below with reference to the attached drawing figures, wherein:

FIG. 1 is an illustration of an example flow diagram for a quantum simulation computing platform for simulation of quantum circuits using Boolean tensor network representations, in accordance with some embodiments of the present disclosure;

FIG. 2A is a diagram illustrating Boolean quantum oracle extraction to a Boolean logic representation of the quantum oracle, in accordance with some embodiments of the present disclosure;

FIG. 2B is a diagram illustrating generation of an oracle tensor network comprising a chain of Boolean tensors from a Boolean decomposition of a quantum oracle;

FIG. 2C is a diagram illustrating tensor components of a chain of tensors of an oracle tensor network representing a quantum oracle;

FIG. 2D is a diagram illustrating construction of a tensor network representation of a quantum circuit comprising an oracle tensor network;

FIG. 3 is a flow diagram showing a method for simulation of quantum circuit oracles using Boolean tensor network representations, in accordance with some embodiments of the present disclosure;

FIG. 4 is a block diagram of an example computing device suitable for use in implementing some embodiments of the present disclosure; and

FIG. 5 is a block diagram of an example data center suitable for use in implementing some embodiments of the present disclosure.

### DETAILED DESCRIPTION

Systems and methods are disclosed related to decomposition of quantum oracles for simulation of quantum computing systems and applications. More specifically, the systems and methods presented in this disclosure facilitate improvements in efficiently simulating quantum circuits with a family of quantum oracles, using tensor network simulation of a chain of small (e.g., two-variable) Boolean function-based tensors. Although the present disclosure may be described with respect to quantum circuit simulation, this is not intended to be limiting, and the systems and methods described herein may be used in augmented reality, virtual reality, mixed reality, robotics, security and surveillance, autonomous or semi-autonomous machine applications, and/or any other technology spaces where the execution of quantum algorithms may be used. Moreover, the present disclosure may be applied, either to the above fields or others not listed, in the context of “quantum inspired” algorithms, which are classical algorithms that adopt aspects of quantum logic, such as a data update using unitary matrices. The systems and methods described herein may be used in generating and/or presenting at least one of virtual reality content, augmented reality content, or mixed reality content.

While quantum computing holds the potential for solving highly complex problems (e.g., using a Variational Quantum Eigensolver to find very precise estimates of energy structures in various molecular systems, or quantum encryption-based communication applications), there are barriers at each developmental stage for designing and testing those quantum circuits due to the limitations of current simulation technologies. One distinct challenge faced with simulating quantum computing systems involves the memory and processing resources of the simulation computing platform that are needed to accurately emulate, manipulate, and probe the quantum state (and its corresponding state vector) of the quantum system being simulated. To accurately represent and manipulate complex state vectors, the memory requirements of a simulation computing platform scale exponentially as a function of the number of qubits that make up the state vector. For example, one form of a straightforward quantum circuit simulation (known as the state vector method) may involve simple matrix-vector multiplication where the simulation platform takes a unitary matrix corresponding to a gate sequence in a quantum circuit and multiplies it with a column vector representing the input state (usually initialized to vacuum state), and computes an output state represented by a resulting column vector. However, this approach is greatly limited as the number of computations and memory requirements scale exponentially as the number of qubits of the quantum circuit increases.

For many quantum computing algorithms, quantum oracles are often used to define abstract operations on a subset of qubits of a quantum circuit. A quantum oracle can be viewed as a compound operator that may be used to generate a Boolean quantity, and may be used to describe a well-defined unitary transformation from one quantum state to another quantum state, and are used in many important quantum algorithms, such as Grover's algorithm (for searching an unsorted database), Shor's algorithm (for factoring large integers), and the Deutsch-Jozsa algorithm (for distinguishing between constant and balanced Boolean functions), to assist in solving problems that are otherwise computationally difficult for classical computers. The process of deriving a quantum gate sequence to represent a given quantum oracle is referred to as “quantum circuit synthesis.” However, directly simulating synthesized quantum circuits for a quantum oracle is challenging for the same reasons that direct simulation of quantum circuits in general is challenging; namely, that the computations and memory requirements scale exponentially as the number of qubits increases.

Tensor network-based quantum circuit simulation is an example of one developing technology for simulating large-scale quantum algorithms (e.g., quantum circuits having 100+qubits) that otherwise are not reachable by the state vector method with existing classical computers. Tensors are a generalization of scalars (0-dimension), vectors (1-dimension), and matrices (2-dimension), to arbitrary numbers of dimensions. A tensor network is a collection of tensors contracted together to form an output tensor. For simulation purposes, quantum algorithms—including those with quantum oracles—can be modeled as a kind of tensor network, for example by translating single-qubit gates to corresponding rank-2 tensors, and two-qubit gates to corresponding rank-4 tensors. Several techniques are presently available to generate a tensor network to represent a quantum oracle for tensor network-based simulation.

For example, one process for constructing a tensor network to represent a quantum circuit is referred to as “gate-based decomposition” which generates the tensor network by decomposing large quantum gates into 1-qubit (1q) and 2-qubit (2q) quantum gates, and then constructing a corresponding tensor network using those decomposed quantum gates. In gate-based decomposition, a circuit corresponding to a quantum algorithm may be defined as a sequence of arbitrary quantum gates. Conventionally, gate-based quantum simulation platforms support a finite number of 1q and 2q gates (having unitary matrices of sizes 2×2 and 4×4, respectively), referred to as the fundamental gate set that facilitates universal quantum computation. To process the sequence of arbitrary quantum gates, the arbitrary quantum gates are decomposed into gates of the fundamental gate set. However, this approach suffers from the creation of an exponentially increasing number of 1q and 2q gates in the gate sequence as the number of involved qubits increases. The computations for the gate-based decomposition involve adding ancilla qubits to the original qubits of the quantum oracle, consuming additional memory and other overhead. The number of ancilla qubits added to perform a gate-based decomposition to arrive at a tensor network for an oracle would depend on the specific problem being solved and the input space size (e.g., the number of input qubits to the oracle). The gate-based decomposition approach can be challenging to implement using tensor network-based quantum circuit simulation since it involves a preprocessing step to generate the small tensors corresponding to the 1q and 2q quantum gates, which can itself result in increased computational intensity and memory usage. Gate-based decomposition is particularly wasteful with respect to multi-controlled gates, which in matrix form are block diagonal matrices that are inherently inefficient in terms of memory utilization.

Singular Value Decomposition (SVD)-based Matrix Product Operator (MPO) techniques represent another process for constructing a tensor network corresponding to a quantum oracle. Using SVD-based MPO techniques, the unitary matrix of a quantum oracle is decomposed into low-rank tensors that are more memory-efficient as compared to memory storage associated with the arbitrary quantum gates of the gate-based decomposition. In SVD-based MPO, the simulation platform discards insignificant singular values based on empirical criteria, a process referred to as “truncation”. However, the SVD-based MPO construction of a tensor network is still quite computationally expensive, with the complexity (2²^{ₙ}), and becomes intractable for large quantum gates, making tensor network simulation impractical. In general, SVD-based MPO creates an approximated MPO form by iteratively performing tensor SVD along adjacent qubit lines. The time complexity of constructing an MPO tensor network using SVD is expensive and impractical for large gates. Moreover, performing SVD requires creating an input unitary matrix of size 2ⁿ×2ⁿ, which is costly in terms of memory. Finally, the final result of SVD is an approximate tensor in MPO form obtained through truncation, which may not meet the desired accuracy to arrive at a valid solution for some tasks.

Other MPO techniques have been proposed to create an exact MPO representation for a multi-controlled quantum gate without the need for performing SVD. For example, a low-rank tensor decomposition method is based on defining fixed tensors for control and target qubits, separately. The method may be generalized to any multi-controlled gate that operates on a single target qubit and reduces storage consumption from exponential to linear in the total number of qubits n in the circuit. However, such methods are only applicable for one multi-controlled gate, while a quantum circuit representing a quantum oracle may include sequences of single-qubit gates, single-controlled gates, and/or multi-controlled gates. As such, simulating a single quantum oracle may involve processing and contracting several MPO tensor networks (e.g., including one for each multi-controlled gate of the quantum oracle).

In contrast to existing technologies, with one or more of the embodiments of this disclosure, an exact MPO tensor network representation for a quantum oracle may be generated without the requirement to reconstruct a new quantum circuit representation corresponding to the quantum oracle, to add ancilla qubits to the quantum oracle, or to perform SVD computations, to arrive at the MPO tensor network. More specifically, with one or more of the embodiments of this disclosure, a quantum oracle belonging to a family of oracles that define a concatenated Boolean function may be expressed as an MPO tensor network comprising a chain of tensors that each comprise easily computable decomposed Boolean logic operations. The resulting MPO tensor network, comprising a chain of two-variable Boolean function-based tensors, may be more efficiently contracted, since a greater number of smaller tensors presents a larger number of options to the simulation platform for establishing an optimal contraction order without storing excessively large intermediate tensors to memory. For other Boolean functions, in some embodiments they may be converted into a concatenated Boolean function, for example by variable reordering to several concatenated Boolean functions and/or by other methods.

For example, in some embodiments, a simulation platform may receive as input a representation of a quantum circuit that includes a quantum oracle, O, where the quantum oracle, O, implements a decomposable Boolean function f:{0, 1}^{m}→{0, 1} which acts on an m-bit binary input and produces a one-bit output. The m-bit binary input comprises the control qubits of the quantum oracle, which may be expressed as:

$$\vert C 〉 = \vert {c}_{1} {c}_{2} … {c}_{m} 〉 = \vert {c}_{1} 〉 ⊗ \vert {c}_{2} 〉 ⊗ … ⊗ \vert {c}_{m} 〉$$

and the solution of the quantum oracle applied onto at least one target qubit |t [symbol] which may be expressed as:

$$O ( \vert C 〉 ⊗ \vert t 〉 ) = \vert C 〉 ⊗ \vert t ⊕ f ( C ) 〉 .$$

In this example, the quantum oracle expresses an abstract circuit unit having m control qubits and one (or more) target qubits. In the above expression, the quantum oracle applies an XOR operation, ⊕, between the Boolean function output of the oracle and the target qubit |t [symbol] . However, as further discussed below, this operation may be generalized to any quantum gate with a custom unitary matrix. It should be noted that a quantum oracle may be represented by a unitary matrix of size 2ⁿ×2ⁿ, or a tensor with 2n modes (e.g., a rank of 2n), with each mode of size two, where n=m (the number of control qubits)+k (the number of target qubits).

In some embodiments, generating the MPO tensor network representation of a quantum oracle may include extracting a Boolean logic representation of at least one quantum oracle from a quantum circuit, and from that representation generating an oracle tensor network that comprises a plurality of Boolean tensors. In some embodiments, a tensor network simulator pre-processing function may input a representation of a quantum circuit and identify operations of the quantum circuit corresponding to a quantum oracle. For example, the tensor network simulator pre-processing function may identify a set of Boolean functions corresponding to a quantum oracle that defines a concatenated Boolean function (or other Boolean functions that may be converted into a concatenated Boolean function). In some embodiments, an input to the tensor network simulator pre-processing function may include one or more identifiers (e.g., labels) that specify which operations of the quantum circuit define a quantum oracle (and/or otherwise specify that the input is quantum oracle) that meets the criteria of comprising concatenated Boolean functions that can be decomposed to produce a chain of two-variable Boolean functions. In other embodiments, a classification algorithm may be applied to determine which operations of the quantum circuit define a quantum oracle (and/or otherwise determine that the input is a quantum oracle). Those two-variable Boolean functions may then be sequenced to create an MPO tensor network as an exact representation of the quantum oracle. In some embodiments, the representation of the quantum circuit received by the tensor network simulator pre-processing function may include more than one quantum oracle. In such cases, the representations of the individual quantum oracles may be extracted and individually processed as described herein.

In some embodiments, the tensor network simulator pre-processing function converts the quantum oracle to an MPO tensor network comprising three tensor classes. The MPO tensor network includes: 1) a root control qubit tensor with three modes as the initial tensor of the MPO tensor network, 2) one or more intermediate control qubit tensors with four modes, and 3) at least one target qubit tensor with three modes as the final tensor of the MPO tensor network. The root control qubit tensor and target qubit tensor each may implement predefined Boolean functions, as described below, while the intermediate control qubit tensors form a chain (e.g., between the root control qubit tensor and the target qubit tensor) comprising the plurality of two-variable Boolean functions derived from the Boolean logic representation of the quantum oracle. For example, the Boolean functions of the Boolean logic representation of the quantum oracle may comprise Boolean functions of three or more variables, where those Boolean functions can be decomposed into the form of two-variable Boolean functions that are operated together.

In some embodiments, the root control qubit tensor essentially implements a one-variable Boolean function which is either an identity operation or a NOT operation. It does not alter the state of a first control qubit, c₁, and may output an initial bonding index, b₁, equal in value to the first control qubit for an identify operation, or complement in value for a NOT operation. In some embodiments, the target qubit tensor applies an XOR operation, ⊕, (or other predetermined unitary matrix operation) between the Boolean function output bonding index, bₘ, from the final intermediate control qubit tensor and the target qubit t, to convert the target qubit, t, to t′=t⊕f(C).

With respect to the intermediate control qubit tensors, decomposition of the quantum oracle into the plurality of two-variable Boolean functions may be applied to quantum oracles that belong to a family of concatenated Boolean operation functions, OPᵢ, that can be expressed as:

$$f ( C ) = ( ( ( ( ( {OP}_{1} ( {c}_{1} ) ) {OP}_{2} {c}_{2} ) {OP}_{3} {c}_{3} ) … ) {OP}_{m} {c}_{m} )$$

where OP₁ is either identity or NOT operation, and each operation OPᵢ (i≥2) represents a Boolean logical operation between the previous bonding index, bᵢ₋₁, and cᵢ control qubit that produces a bonding index, bᵢ, linked to the next tensor in the chain of the MPO tensor network. In some embodiments, the operations, OPᵢ, may be individually decomposed from a Boolean logic representation of the quantum oracle based on its unitary matrix representation. For example, in some embodiments, the tensor network simulator pre-processing function may perform a decomposition by matching patterns of 4×4 sub-matrix elements of the unitary matrix representation to patterns of predefined Boolean functions based on patterns (such as truth tables) stored in a memory, a lookup table, and/or other matching algorithms. For example, the tensor network simulator pre-processing function may iteratively evaluate the unitary matrix representation to identify 4×4 sub-matrix elements having a pattern that matches a truth table pattern corresponding to a specific Boolean operation (such as, but not limited to, AND, OR, XOR, NAND, NOR, and XNOR operators) and accordingly create a chain of intermediate control qubit tensors, each performing a Boolean function identified from the matching. Such a matching operation may be implemented with only minimal computational efforts as compared to algorithms such as SVD. It should be noted that more complex Boolean functions can be constructed using combinations of AND, OR, and NOT operations, and that each of the AND, OR, and NOT operations may be constructed using either NAND or NOR functions. As such, in some embodiments, the two-variable Boolean functions may be further decomposed into sequences of AND, OR, NOT, NAND and/or NOR operations.

In some embodiments, an MPO sub-tensor network for the oracle function may be generated by evaluating the bonding indices on the control qubits in sequence, using the Boolean result of the previous bonding index, bᵢ₋₁, from the previous tensor to compute the current bonding index, bᵢ, for each of the intermediate control qubit tensors, which may be expressed as:

$$\begin{matrix}{b}_{i} = {b}_{i - 1} {OP}_{i} {c}_{i} = O {P}_{i} ( {b}_{i - 1} , {c}_{i} ) ∀ i \geq 2 , & {b}_{1} = {c}_{1} or \end{matrix} {b}_{1} = \overline{{c}_{1}} .$$

The bonding indices, bᵢ, express the result of a Boolean function that is either 0 or 1 and therefore have a dimension of size two. Moreover, each input/output mode of a tensor is of size two. Therefore, a quantum oracle comprising a function of concatenated Boolean functions may be converted to an equivalent MPO oracle tensor network comprising a root control qubit tensor with 3 modes (c₁, c′₁, b₁) of dimension (2, 2, 2), m−1 intermediate control qubit tensors of 4 modes (bᵢ₋₁, cᵢ, c′ᵢ, bᵢ) of dimension (2, 2, 2, 2), and at least one target qubit tensor with 3 modes (bₘ, t, t′) of dimension (2, 2, 2), resulting in an MPO tensor network that more efficiently scales linearly with the total qubit number, n, with respect to memory usage, as opposed to scaling exponentially as n increases.

In some embodiments, simulation of a quantum circuit using the MPO tensor network representation of the quantum oracle may be executed by a tensor network-based simulation platform that comprises a contraction optimization stage and an execution stage. The contraction optimization stage may input a tensor network representation of the quantum circuit (e.g., a full tensor network which includes the constructed MPO sub-tensor network corresponding to the quantum oracle) and perform a pathfinding algorithm, or other tensor contraction optimization algorithm, to iteratively identify tensors that can be contracted together in order to find an optimal contraction order to pair tensors for more efficient execution by the execution stage. The Boolean function-based decomposition of the quantum oracle into a chain of simple two-variable Boolean functions provides the contraction optimization stage with greater flexibility in finding an optimal contraction order and avoids the need for the contraction optimization stage to store large intermediate tensors while prioritizing and performing tensor contraction operations.

In general, a Boolean logic representation of a quantum oracle may be extracted by the tensor network simulator pre-processing function from a quantum circuit. The tensor network simulator pre-processing function performs a decomposition of complex tensors present in the Boolean logic representation into a set of smaller (e.g., two-variable) Boolean functions. Once the complex tensors are decomposed, an oracle tensor network (e.g., such as an MPO tensor network) may be created based on the smaller two-variable Boolean functions. The oracle tensor network may be incorporated into a tensor network representation comprising a full tensor network for the quantum circuit. Tensor contraction optimization may be performed on the full tensor network, and the resulting contraction-optimized tensor network applied to a simulation platform execution stage to produce a simulation of the quantum circuit. In some embodiments, results of simulating a quantum circuit may include target qubit states that function as inputs to other quantum algorithms and/or gates for a larger quantum circuit simulation. In some embodiments, based on the simulation of the larger quantum circuit, the simulation platform may further extract a representation of at least a component of a state vector of the quantum circuit, extract a representation of at least one component of one or more product states of the quantum circuit, obtain an expectation value of the original quantum circuit, compute the reduced density matrix for a subset of qubits, and/or sample at least one component of one or more product states of the final state. For example, in some embodiments, an expectation value derived from a quantum simulation result may be used as an input, or otherwise to inform a machine learning algorithm and/or a classical computing algorithm, executing on the simulation platform.

Disclosed embodiments may be comprised in a variety of different systems, such as automotive systems (e.g., a control system for an autonomous or semi-autonomous machine, and/or a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations using (large) language models, systems for performing light transport simulation, systems for performing collaborative content creation for 3D assets, systems implemented at least partially using cloud computing resources, and/or other types of systems.

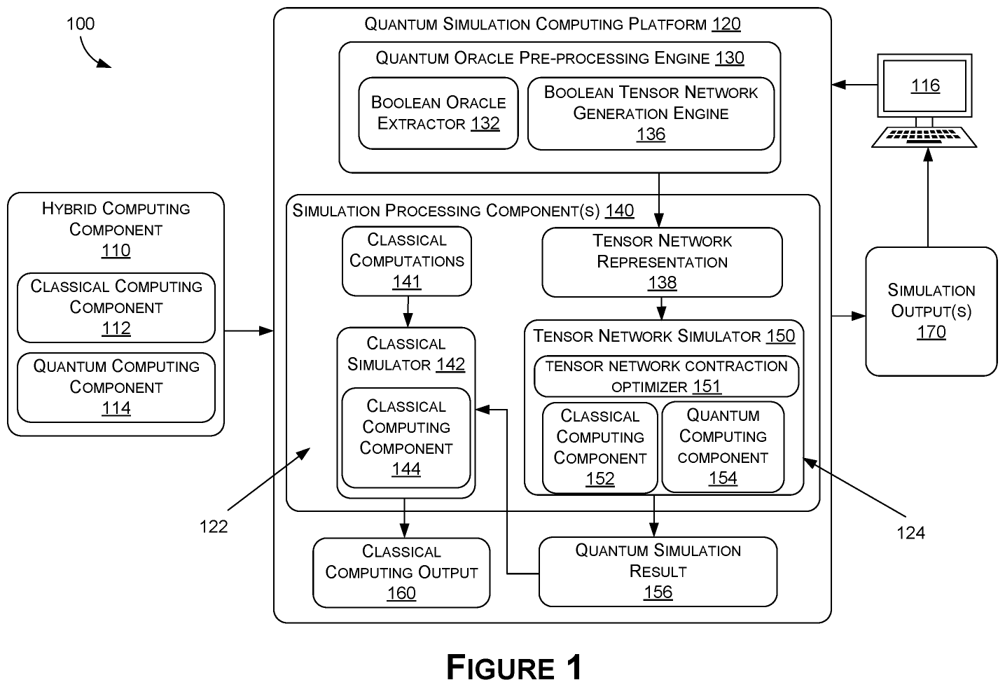

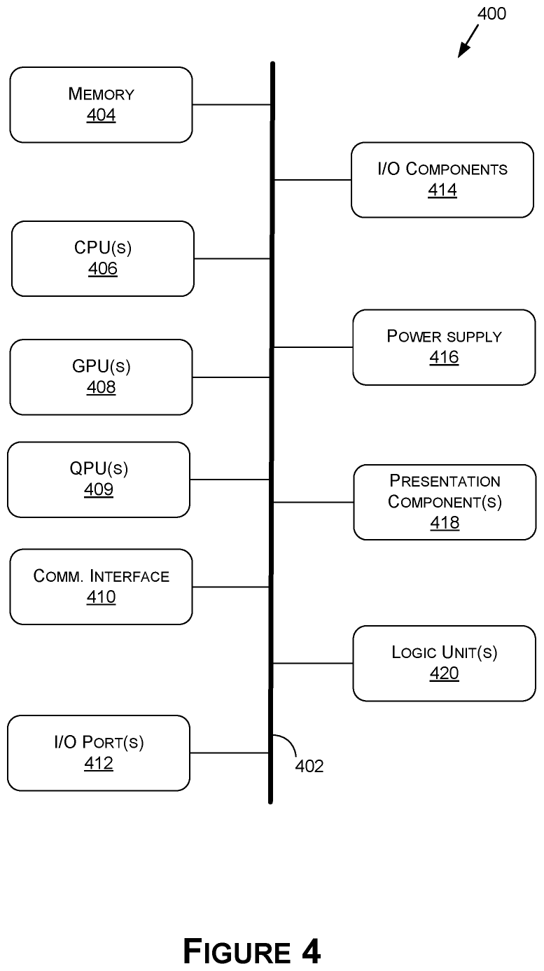

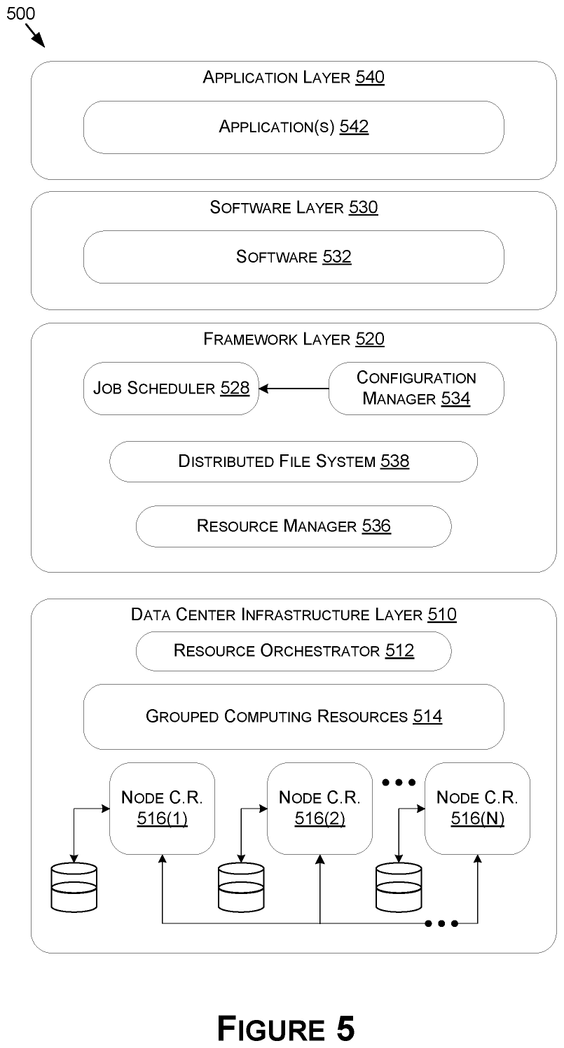

With reference to FIG. 1, FIG. 1 is a data flow diagram illustrating a simulation environment 100 that includes an example quantum simulation computing platform 120, in accordance with some embodiments of the present disclosure. This and other arrangements described herein are set forth only as examples. Other arrangements and elements (e.g., machines, interfaces, functions, orders, groupings of functions, etc.) may be used in addition to, or instead of, those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example computing device 400 of FIG. 4, and/or example data center 500 of FIG. 5.

The simulation environment 100 may include generating and/or receiving a hybrid computing component 110 using a quantum simulation computing platform 120. The hybrid computing component 110 may include at least one quantum computing component 114 that represents a quantum circuit or algorithm, such as a quantum oracle. In some embodiments, such as the embodiment shown in FIG. 1, the hybrid computing component 110 may include a classical computing component 112 (e.g., software code for execution on a non-quantum processor such as a central processing unit (CPU), or graphics processing unit (GPU), or other processing unit (e.g., DPU) or hardware accelerator). In this context, the hybrid computing component 110 may be referred to as a hybrid algorithm in that the hybrid computing component 110 may include a quantum computing component 114 or a combination of a classical computing component 112 with a quantum computing component 114. In some embodiments, the hybrid computing component 110 may at least in part comprise hardware description language (HDL) code that describes the structure and/or behavior of a circuit (either classical, quantum, or a combination thereof) to be simulated by the quantum simulation computing platform 120. As shown in FIG. 1, the quantum simulation computing platform 120 comprises quantum oracle pre-processing engine 130 (e.g., software executed on platform 120 to initiate and control the execution of simulations based on the hybrid computing component 114) and one or more simulation processing components 140 (which are the underlying processing units that execute the simulation based on the hybrid computing component 110). The quantum simulation computing platform 120 may be used for processing (e.g., compiling and/or executing) a quantum circuit that comprises a quantum oracle as disclosed herein. In some embodiments, the quantum simulation computing platform 120 may be used for performing a quantum state preparation.

In some embodiments, a user device 116 comprising a human machine interface (HMI) may be coupled to the quantum simulation computing platform 120 to interface with the quantum oracle pre-processing engine 130 to control and/or monitor one or more aspects of a simulation. In some embodiments, the quantum simulation computing platform 120 may generate one or more simulation outputs 170 for display at the user device 116 based on the hybrid computing component 110, and/or for use as input to other systems. In some embodiments, the user device 116 may comprise a network node coupled to the quantum simulation computing platform 120 via one or more networks, such as but not limited to those described herein. Moreover, the quantum simulation computing platform 120 may, at least in part, be hosted using one or more cloud-based platforms and may communicate over one or more networks, such as but not limited to those described herein.

In some embodiments, the quantum simulation computing platform 120 may generate a global simulation that simulates a virtual world or environment (e.g., a simulated environment) that may include artificial intelligence (AI) vehicles or other objects (e.g., pedestrians, animals, etc.), hardware-in-the-loop (HIL) vehicles or other objects, software-in-the-loop (SIL) vehicles or other objects, and/or person-in-the-loop (PIL) vehicles or other objects. One or more outputs from the global simulation may be presented by the user device 116. The global simulation may be maintained within an engine (e.g., a game engine), or other software-development environment, which may include a rendering engine (e.g., for 2D and/or 3D graphics), a physics engine (e.g., for collision detection, collision response, etc.), a generative AI model, a large language model, sound, scripting, animation, AI, networking, streaming, memory management, threading, localization support, scene graphs, cinematics, and/or other features.

The simulation processing component(s) 140 may include any number of CPU(s), GPU(s), Quantum Processing Unit(s) (QPU(s)), quantum computing resources, and/or a combination thereof. In some embodiments, the simulation processing component(s) 140 may be bifurcated into a classical simulation path 122 and a quantum simulation path 124. In some embodiments, the simulation processing component(s) 140 may comprise the quantum simulation path 124 without the classical simulation path 122.

The classical simulation path 122 may comprise a classical simulator 142 that comprises one or more classical computing components 144 (e.g., CPU(s), GPU(s), or other processing units) that execute simulations (which may comprise at least in part a circuit simulation) based on classical algorithms 141 obtained or derived from the classical computing component 112. When the hybrid computing component 110 includes a classical computing component 112, the quantum oracle pre-processing engine 130 applies the one or more classical algorithms 141 to the classical computing components 144 for execution. The classical computing component(s) 144 executes the classical algorithm(s) 141 to generate a classical computing output 160.

In some embodiments, quantum simulation path 124 may comprise a tensor network simulator 150 that may include computing resources to execute quantum circuit simulations (e.g., one or more simulations of the execution of quantum algorithms on a quantum processor). In some embodiments, tensor network simulator 150 may simulate a quantum circuit comprising the quantum oracle. The tensor network simulator 150 may comprise computing resources that include one or more classical computing components 152 (e.g., CPU(s), GPU(s), or other processing units) that execute quantum circuit simulation algorithms based on a tensor network representation 138. The tensor network representation 138 may be derived from the quantum computing component 114, as discussed herein. The classical computing components 144 and/or classical computing components 152 may, in some embodiments, be implemented using either shared processing resources, or distinct processing resources. In some embodiments, the tensor network simulator 150 may comprise computing resources that include one or more classical computing components 152 (e.g., CPU(s), GPU(s), or other processing units) and/or a quantum computing component 154 (e.g., a QPU and/or other quantum computing resource).

As shown in FIG. 1, in some embodiments, the quantum oracle pre-processing engine 130 may include a Boolean oracle extractor 132 and a Boolean tensor network generation engine 136. The tensor network simulator 150 may execute quantum circuit simulations based on the tensor network representation 138 derived from the quantum computing component 114 by the quantum oracle pre-processing engine 130.

The tensor network simulator 150 may process the tensor network representation 138 to compute an output comprising a quantum simulation result 156. For example, the output of a tensor network simulation can be an expectation value, sampling, a reduced density matrix, a single and/or batched bit-string amplitude, and/or other statistical representatives. The quantum simulation result 156 may be a representation of at least a component of the state vector (e.g., a final or non-final state) for a quantum circuit (e.g., quantum computing component 114) and/or represent a resulting state of one or more target qubits of a quantum oracle. For example, the quantum simulation result 156 may include, but is not limited to, a resulting state of one or more target qubits of a quantum oracle, an expectation value of the original quantum circuit represented by quantum computing component 114, a sample for a subset of qubits of the quantum circuit, a measurement of a quantum state, and/or a norm or other statistics representative of the quantum state. The quantum simulation result 156 may comprise measurements of a state of one or more qubits. In some embodiments, to produce quantum simulation result 156, the tensor network simulator 150 may extract a representation of at least a component of a state vector of the quantum circuit, extract a representation of at least one component of one or more product states of the quantum circuit, obtain an expectation value of the original quantum circuit, sample at least one component of one or more product states of the final state, and/or compute a norm of the final state vector. For example, in some embodiments, an expectation value derived from a quantum simulation result 156 may be used as an input to the classical simulator 142, and/or to inform a machine learning algorithm executing on the quantum simulation computing platform 120.

In some embodiments, the quantum simulation result 156 may be read as an input by the classical simulator 142 and used in the process of computing the classical computing output 160. The simulation output(s) 170 generated by the processing of the hybrid computing component 110 using the quantum simulation computing platform 120 may comprise the quantum simulation result 156 and/or the classical computing output 160. In some embodiments, the simulation output(s) 170 may be fed to the user device 116 and/or other systems for review and/or further analysis.

As mentioned above, the two primary components of quantum circuits are qubits and quantum logical gates. The quantum states of all qubits can be encapsulated by the state vector at any point along the horizontal lines corresponding to the qubits. The quantum states of all qubits may be represented as a complex state vector in a Hilbert space. For example, a qubit may be at a state of

$$\vert 0 〉 = [ \begin{matrix}1 \\ 0\end{matrix} ] or \vert 1 〉 = [ \begin{matrix}0 \\ 1\end{matrix} ] .$$

During the execution of a quantum circuit, the actual qubit state of any given qubit in a system is unknown, but may be expressed as |ϕ [symbol] =α|0 [symbol] +β|1) where |α|² is the probability of the qubit's state being |0 [symbol] , and |β|² is the probability of the qubit's state being |1 [symbol] after measurement. A quantum system of n qubits in a product state may be represented as follows:

$${{{{\vert ψ 〉 = \vert ϕ 〉}_{1} ⊗ \vert ϕ 〉}_{2} ⊗ \vert ϕ 〉}_{3} … ⊗ \vert ϕ 〉}_{n}$$

where |ϕ [symbol] ᵢ is a single-qubit state for the i-th qubit. Generally speaking, the quantum state vector comprises a list of coefficients that specify the weights of the individual product states. A quantum operation performed by a quantum gate to manipulate the quantum state vector may involve just a single qubit (e.g., modeled as a 2×2 gate matrix), or involve some number m qubits of the n qubits (and accordingly be modeled as a 2^{m}×2^{m} gate matrix). The state vector |ψ [symbol] of a quantum circuit at any given point along the execution path of the quantum circuit may represent the cumulative operations performed by quantum gate operations on each qubit from their initial condition to that given point along the circuit execution paths.

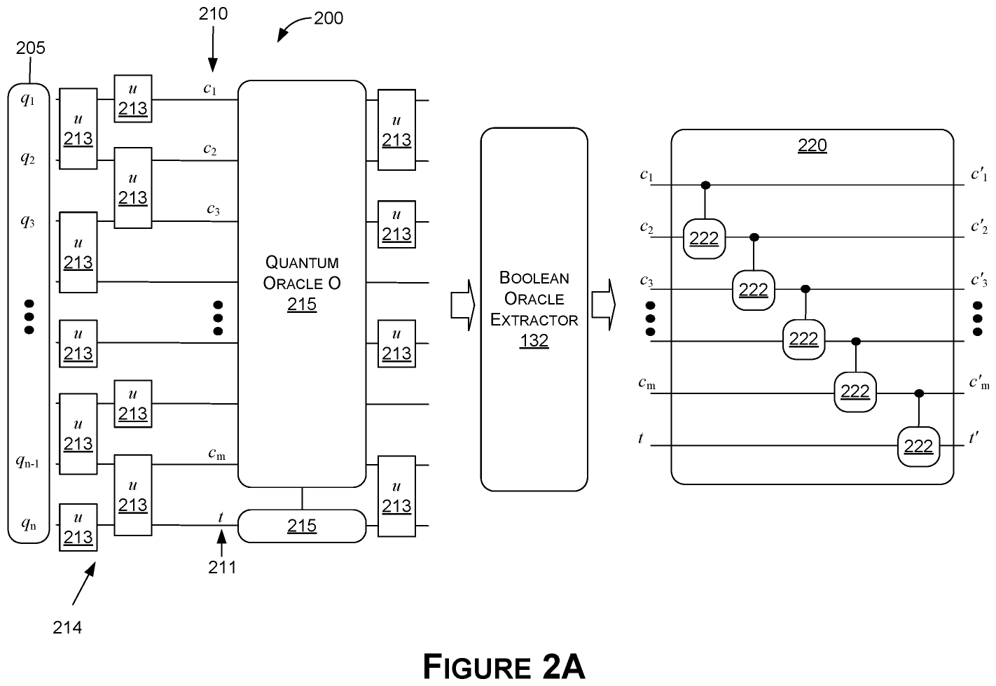

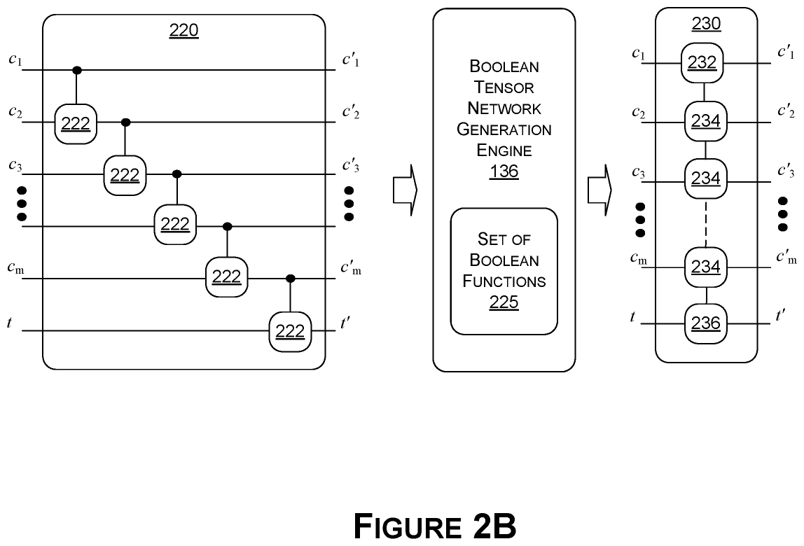

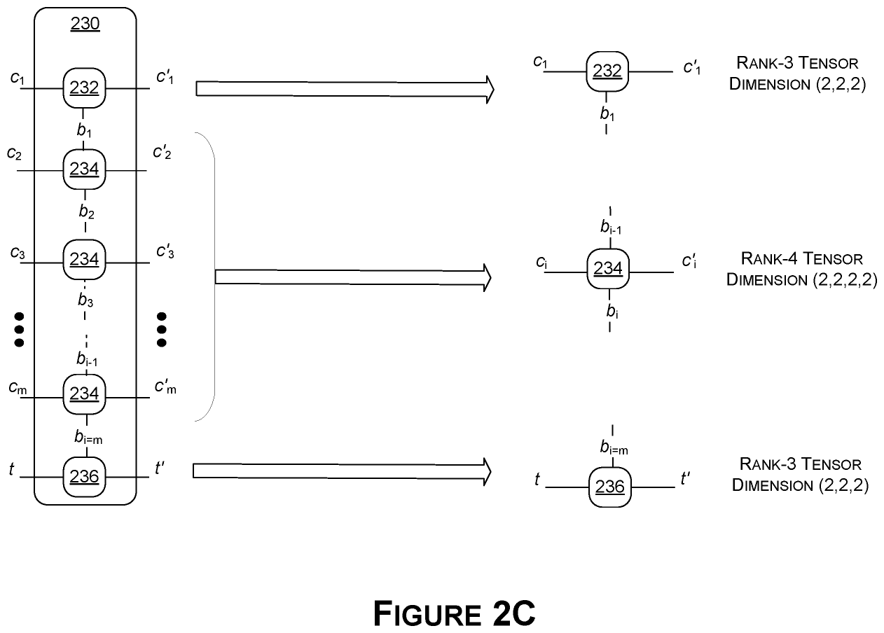

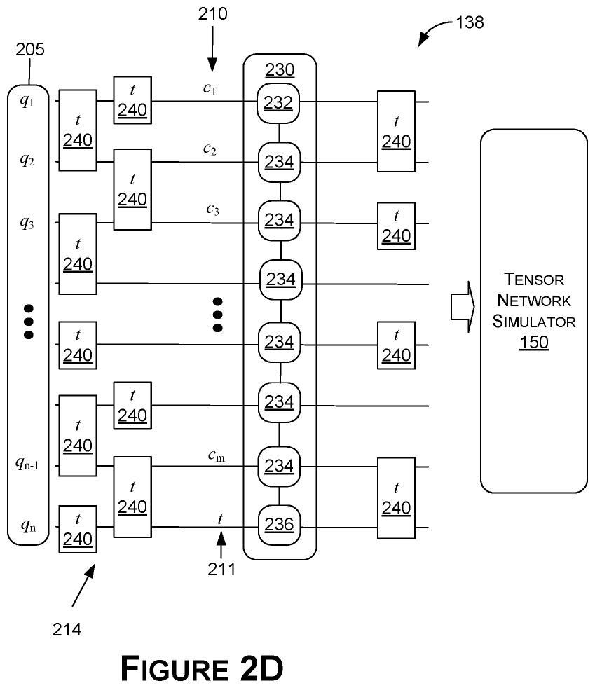

As an example, FIG. 2A illustrates a generalized example of a quantum circuit 200 that includes a quantum oracle 215, that may be evaluated and/or simulated by the quantum simulation computing platform 120 using a tensor network representation. In this example, quantum circuit 200 comprises an “n”-qubit system of qubits q₁, q₂, q₃, . . . , qₙ. (shown at 205) of which “m” qubits are controls c₁, c₂, c₃, . . . , cₘ for the quantum oracle 215 (as illustrated at 210), and at least one qubit comprises a target qubit, t, of the quantum oracle 215 (as shown at 211). As the example quantum circuit 200 is executed, each of the qubits q₁, q₂, q₃ . . . qₙ is operated on according to one or more quantum logic gates 213 (which may simply be referred to as gates) positioned along a respective circuit path 214 for a respective qubit, and according to operations of the quantum oracle 215. In some embodiments, Boolean functions of the quantum oracle 215 will act on the subset of “m” qubits involved with the quantum oracle 215, but not the other quantum logic gates 213. It should be noted that the number of qubits and particular configuration of quantum gates shown in FIG. 2A are provided for the purpose of illustrating a structure of a quantum circuit, and are not limiting features of embodiments of this disclosure. Embodiments may be applied to other quantum circuits having state vectors, quantum operators and circuit path configurations different from those shown in the various figures illustrated herein. A quantum operation performed by quantum circuit 200 may involve just a single qubit (and therefore be modeled as a 2×2 gate matrix), or involve some number “a” qubits of the “n” qubits 210 (and accordingly be modeled as a 2^{a}×2^{a} gate matrix). Moreover, a gate of quantum circuit 200 may manipulate the state of one qubit based on the state of another qubit. The state vector |ψ [symbol] of quantum circuit 200 at any given point along the execution path may represent the cumulative operations performed by quantum gates 213 and/or the quantum oracle 215 on each qubit from their initial condition to that given point along the circuit execution paths 214.

As further shown in FIG. 2A, the Boolean oracle extractor 132 may receive a representation of the quantum circuit 200 (e.g., based on the quantum computing component 114) and extract a Boolean logic representation 220 of the quantum oracle 215 that comprises a plurality of Boolean functions 222. In some embodiments, the Boolean oracle extractor 132 may input a representation of a quantum circuit 200, and identify operations of the quantum circuit 200 corresponding to a quantum oracle. For example, the Boolean oracle extractor 132 may identify from the quantum circuit 200 a set of Boolean functions corresponding to a quantum oracle that defines a concatenated Boolean function. In some embodiments, an input to the Boolean oracle extractor 132 may include one or more identifiers (e.g., one or more labels included with the quantum computing component 114) that specify which operations of the quantum circuit 200 define a quantum oracle (and/or otherwise specify that the input is quantum oracle) that meets the criteria of comprising concatenated Boolean functions that can be decomposed into a chain of two-variable Boolean functions. In other embodiments, Boolean oracle extractor 132 may apply a classification algorithm to determine which operations of the quantum circuit 200 define a quantum oracle (and/or otherwise determine that the input is a quantum oracle). In some embodiments, the representation of the quantum circuit 200 received by the Boolean oracle extractor 132 may include a quantum oracle that can be converted to several concatenated Boolean functions that meet criteria. For example, Boolean oracle extractor 132 may identify other Boolean functions from quantum circuit 200 and convert them to one or more concatenated Boolean functions (e.g., by variable reordering and/or other methods).

In some embodiments, the representation of the quantum circuit 200 received by the Boolean oracle extractor 132 may include more than one quantum oracle. In such cases, the representations of the individual quantum oracle circuits may be extracted and converted by the Boolean oracle extractor 132 to a Boolean logic representation 220 comprising Boolean functions 222 and individually processed and described herein.

As shown in FIG. 2B, the Boolean logic representation 220 produced by the Boolean oracle extractor 132 may be transformed by the quantum oracle pre-processing engine 130 to an oracle tensor network 230 representing the quantum oracle 215. As discussed below, the resulting oracle tensor network 230 may be incorporated into the tensor network representation 138 in order to simulate quantum circuit 200. In some embodiments, the Boolean functions 222 of the quantum oracle's Boolean logic representation 220 may be decomposed into a plurality of two-variable Boolean functions, OPᵢ, by the Boolean tensor network generation engine 136. In some embodiments, the operations, OPᵢ, may be individually decomposed from the Boolean functions 222 of the quantum oracle's Boolean logic representation 220 based on the unitary matrix representation for the Boolean logic representation 220. For example, in some embodiments, the Boolean tensor network generation engine 136 may perform a decomposition by matching patterns of 4×4 sub-matrix elements of unitary matrix representations to patterns of predefined Boolean functions using patterns (such as truth tables) stored in a memory of the platform 120 and/or using a matching algorithm. For example, the Boolean tensor network generation engine 136 may iteratively evaluate the unitary matrix representation to identify 2×2 and/or 4×4 sub-matrix elements having a pattern that matches a truth table pattern corresponding to a specific Boolean function (such as, but not limited to, AND, OR, XOR, NAND, NOR, and XNOR operators) and accordingly create a chain of intermediate control qubit tensors, each performing a Boolean function identified from the matching. Such a matching operation may be implemented by a Boolean tensor network generation engine 136 with only minimal computational efforts as compared to algorithms such as SVD. As mentioned above, the set of two-variable Boolean functions determined by Boolean tensor network generation engine 136 from the Boolean logic representation 220 may be further decomposed by Boolean tensor network generation engine 136 into sequences of AND, OR, NOT, NAND and/or NOR operations.

In some embodiments, a set of two-variable Boolean functions 225 decomposed by the Boolean tensor network generation engine 136 from the Boolean logic representation 220 may then be sequenced by the Boolean tensor network generation engine 136 to create the oracle tensor network 230 (e.g., an MPO sub-tensor network) that is an exact representation of the Boolean logic representation 220 for the quantum oracle 215. In some embodiments, the Boolean tensor network generation engine 136 processes the set of two-variable Boolean functions 225 to generate an oracle tensor network 230 comprising three tensor classes, as shown in FIG. 2B and further in FIG. 2C. In some embodiments, the oracle tensor network 230 may comprise an MPO tensor network that includes a root control qubit tensor 232, one or more intermediate control qubit tensors 234, and at least one target qubit tensor 236 as the final tensor of a MPO sub-tensor network.

The root control qubit tensor 232 and the target qubit tensor 236 each may implement predefined Boolean functions, as described below, while the one or more intermediate control qubit tensors 234 form a chain (e.g., between the root control qubit tensor 232 and the target qubit tensor 236) derived from the plurality of two-variable Boolean functions 225 produced by the Boolean tensor network generation engine 136.

As illustrated in FIG. 2C, in some embodiments the root control qubit tensor 232 essentially implements an identity (or NOT) operation that does not alter the state of a first control qubit, c₁, and outputs an initial bonding index, b₁, equal (or complement) in value to the first control qubit. In some embodiments, the target qubit tensor 236 may apply an XOR operation, ⊕, (or other predetermined unitary matrix operation) between the Boolean function output bonding index, bₘ, from the final intermediate control qubit tensor 234 and the target qubit t, to convert the target qubit, t, to t′=t⊕f(C). As such, the root control qubit tensor 232 and target qubit tensor 236 may be generated by the Boolean tensor network generation engine 136 independently from the one or more intermediate control qubit tensors 234, for example, as discussed in greater detail below.

With respect to the root control qubit tensor 232, an oracle tensor network 230 representing the quantum oracle 200 may be generated by the Boolean tensor network generation engine 136 beginning with this tensor. By definition, the first input control qubit, c₁, of the oracle tensor network 230 (such as an MPO tensor network) is expected to be equal to the first output control qubit, c′₁, and the resulting first bonding index, b₁ (e.g., that connects the root control qubit tensor 232 to the first intermediate control qubit tensor 234), is also expected to equal the first input control qubit, c₁ for identity operation, b₁=c₁. Accordingly, the valid sets of values for (c₁c′₁, b₁) for the root control qubit tensor 232 are (00,0) and (11,1). The possible mode values of the root control qubit tensor can therefore be represented by the truth table:

b₁

| c₁c′₁ | 0 | 1 |
|---|---|---|
| 00 | 1 | 0 |
| 01 | 0 | 0 |
| 10 | 0 | 0 |
| 11 | 0 | 1 |

While for NOT operation, b₁=c̅₁̅, the resulting first bonding index, b1, is expected to be equal to the complement of the first control qubit, c₁, and the valid sets of values for (c₁c′₁, b₁) for the root control qubit tensor 232 are (00,1) and (11,0). In the case the tensor elements may be represented by:

b₁

| c₁c′₁ | 0 | 1 |
|---|---|---|
| 00 | 0 | 1 |
| 01 | 0 | 0 |
| 10 | 0 | 0 |
| 11 | 1 | 0 |

With respect to the intermediate control qubit tensor(s) 234, an oracle tensor network 230 representing the quantum oracle 215 may be generated by the Boolean tensor network generation engine 136 and may comprise one or more of such rank-4 tensors. Given a quantum oracle 215 comprising m control qubits, there are m−1 tensors in this qubit tensor class. As with the root control qubit tensor 232, for the individual intermediate control qubit tensor(s) 234, an input control qubit, cᵢ, is expected to be equal to the output control qubit, c′ᵢ. However, the output bonding index, bᵢ, of an intermediate control qubit tensor 234 is computed as a function of both cᵢ and the previous bonding indices, bᵢ₋₁, from the prior tensor in the tensor network chain. That is, bᵢ=bᵢ₋₁ OPᵢ cᵢ. Accordingly, valid sets of values for bᵢ₋₁cᵢc′ᵢ, are 000, 011, 100 and 111. Computation of bᵢ depends on the particular Boolean function of OPᵢ applied to bᵢ₋₁ and cᵢ. The possible mode values of an intermediate control qubit tensor 234 can therefore be represented by Boolean tensor network generation engine 136 as:

bᵢ

| bᵢ₋₁cᵢc′ᵢ | 0 | 1 |
|---|---|---|
| 000 | O̅P̅ᵢ̅(̅0̅,̅ 0̅)̅ | OPᵢ(0, 0) |
| 001 | 0 | 0 |
| 010 | 0 | 0 |
| 011 | O̅P̅ᵢ̅(̅0̅,̅ 1̅)̅ | OPᵢ(0, 1) |
| 100 | O̅P̅ᵢ̅(̅1̅,̅ 0̅)̅ | OPᵢ(1, 0) |
| 101 | 0 | 0 |
| 110 | 0 | 0 |
| 111 | O̅P̅ᵢ̅(̅1̅,̅ 1̅)̅ | OPᵢ(1, 1) |

which includes all tensor elements for the rank-4 intermediate control qubit tensor 234, with entries of the form OPᵢ(bᵢ₋₁,cᵢ) computed using the relationship bᵢ=bᵢ₋₁OPᵢcᵢ. Note that the barred expression O̅P̅ᵢ̅(̅b̅ᵢ̅₋̅₁̅,̅c̅ᵢ̅)̅ r̅e̅p̅r̅e̅s̅e̅n̅t̅s̅ t̅h̅e̅ n̅e̅g̅a̅t̅i̅o̅n̅ o̅f̅ O̅P̅ᵢ̅(̅b̅ᵢ̅₋̅₁̅,̅c̅ᵢ̅)̅,̅ w̅h̅i̅c̅h̅ e̅n̅s̅u̅r̅e̅s̅ t̅h̅a̅t̅ t̅h̅e̅ m̅a̅t̅r̅i̅x̅ p̅r̅o̅v̅i̅d̅e̅s̅ o̅n̅e̅-̅t̅o̅-̅o̅n̅e̅ m̅a̅p̅p̅i̅n̅g̅ f̅r̅o̅m̅ i̅n̅p̅u̅t̅ (̅b̅ᵢ̅₋̅₁̅,̅c̅ᵢ̅)̅ to output (bᵢ). As discussed above, a Boolean function of OPᵢ may be one of a finite set of Boolean functions (e.g., such as AND, OR, XOR, NAND, NOR, and XNOR operators) on control qubits or their negations that is selected based on a Boolean function identified for this intermediate control qubit tensor 234 during the decomposition of the quantum oracle 200 discussed above. As such, in some embodiments a tensor matrix template corresponding to a given Boolean function, OP, may be reused by the Boolean tensor network generation engine 136 to create tensors of an intermediate control qubit tensor 234 for each instance of that given Boolean function, OP.

With respect to the target qubit tensor(s) 236, this corresponds to the last tensor of the oracle tensor network 230. As discussed above, in some embodiments the quantum oracle may apply an XOR operation, ⊕, between the Boolean function output bonding index, bₘ, from the final intermediate control qubit tensor 234 and the target qubit |t [symbol] . In other words, when the bonding index, bₘ, input to a target qubit tensor 236 is zero, the target qubit |t [symbol] remains unchanged so that t and t′ are equal (e.g., tt′=00 or 11). When the bonding index, bₘ, input to the target qubit tensor 236 is instead one, the target Boolean function of the target qubit tensor 236 is applied to change the target qubit to t′=t⊕f(C), which flips an input target qubit value of 1 to an output target qubit value of 0, and an input target qubit value of 0 to an output target qubit value of 1. The possible mode values of this target tensor can thus be represented by the truth table:

tt′

| bₘ | 00 | 01 | 10 | 11 |
|---|---|---|---|---|
| 0 | 1 | 0 | 0 | 1 |
| 1 | 0 | 1 | 1 | 0 |

The shape (2, 2, 2) rank-3 target qubit tensor may be directly constructed by filling in the corresponding entries from the table.

Although in the example above, the oracle tensor network 230 applies an XOR operation, ⊕, to convert the target qubit, t, to t⊕f(C), in other embodiments, this operation may be generalized to any quantum gate having a unitary matrix, G, such as:

$$G = [ \begin{matrix}{v}_{00} & {v}_{01} \\ {v}_{10} & {v}_{11}\end{matrix} ] ,$$

by modifying the unitary matrix of the rank-3 target tensor to construct a target tensor 236 of size 2×4 that corresponds to assignments (bₘ, tt′) as:

tt′

| bₘ | 00 | 01 | 10 | 11 |
|---|---|---|---|---|
| 0 | 1 | 0 | 0 | 1 |
| 1 | ν₀₀ | ν₀₁ | ν₁₀ | ν₁₁ |

which can still be represented as a tensor of shape (2, 2, 2). Moreover, as discussed above, in some embodiments the quantum oracle 215 may act on an arbitrary number, k, of target qubits (where k≥1, with the total number of qubits n=m+k). In such embodiments, the unitary matrix for the target qubits may be a matrix of size 2^{k}×2^{k}, making the final tensor 236 of the oracle tensor network 230 a target tensor of size 2×2^{2k} of shape (2, 2^{k}, 2^{k}).

An MPO oracle tensor network 230 for the quantum oracle 215 may thus be generated by evaluating the bonding indices on the control qubits in sequence, using the Boolean result of the previous bonding index, bᵢ₋₁, from the previous tensor to compute the current bonding index, bᵢ, for each of the intermediate control qubit tensors. The bonding indices, bᵢ. of the oracle tensor network 230 express the result of a Boolean function that is either 0 or 1 and therefore have a dimension of size two. Therefore, a quantum oracle 215 comprising a function of concatenated Boolean functions may be converted to an equivalent MPO oracle tensor network 230 comprising the root control qubit tensor 232 with 3 modes, one or more intermediate control qubit tensors 234 with 4 modes, and at least one target qubit tensor 236 with 3 modes, resulting in an oracle tensor network 230 that more efficiently scales linearly with the total qubit number, m, of the quantum oracle 215 with respect to memory usage, as opposed to scaling exponentially as m increases.

FIG. 2D is a diagram illustrating assembly of the tensor network representation 138 corresponding to the quantum circuit 200. As shown in FIG. 2D, each of the standard quantum logic gates 213 of the quantum circuit 200 may be converted into corresponding tensor network gate operators 240 operating on the qubits 205 of the tensor network representation 138. To represent the quantum oracle 215, the Boolean tensors 232, 234 and 236 of the oracle tensor network 230 generated by the Boolean tensor network generation engine 136 provide a sub-tensor network that may incorporated into the tensor network representation 138 in place of the quantum oracle 215. The root control qubit tensor 232 may correspond with the first control qubit, c₁, of the quantum oracle 215, and the intermediate control qubit tensors 234 respectively corresponding with the next m−1 control qubits, c₂ to cₘ of the quantum oracle 215. The target qubit tensor 236 of the oracle tensor network 230 may correspond with the target qubit(s), t, of the quantum oracle 215. The result is a tensor network representation 138 that comprises a full tensor network (e.g., incorporating the oracle tensor network 230 as an MPO sub-tensor network with the tensor network gate operators 240) that may be applied to the tensor network simulator 150 to execute a simulation of the quantum circuit 200, as described herein.

Referring again to FIG. 1, in some embodiments, the tensor network simulator 150 may implement two stages to perform a simulation of the quantum circuit 200 using the tensor network representation 138, one being a contraction path optimization and the other being execution of pairwise contractions. Accordingly, the tensor network simulator 150 may comprise a tensor network contraction optimizer 151. The tensor network contraction optimizer 151 may input the tensor network representation 138 and perform a pathfinding algorithm, or other tensor contraction optimization algorithm, to iteratively identify tensors of the tensor network representation 138 that can be contracted together in order to find an optimal contraction order to pair tensors for more efficient execution by the tensor network simulator 150. The Boolean function-based decomposition of the quantum oracle 215 into an oracle tensor network 230 comprising a chain of simple two-variable Boolean functions incorporated within the tensor network representation 138 provides the tensor network contraction optimizer 151 with greater flexibility in finding an optimal contraction order and avoids the need for the tensor network contraction optimizer 151 to store large intermediate tensors while prioritizing and performing tensor contraction operations.

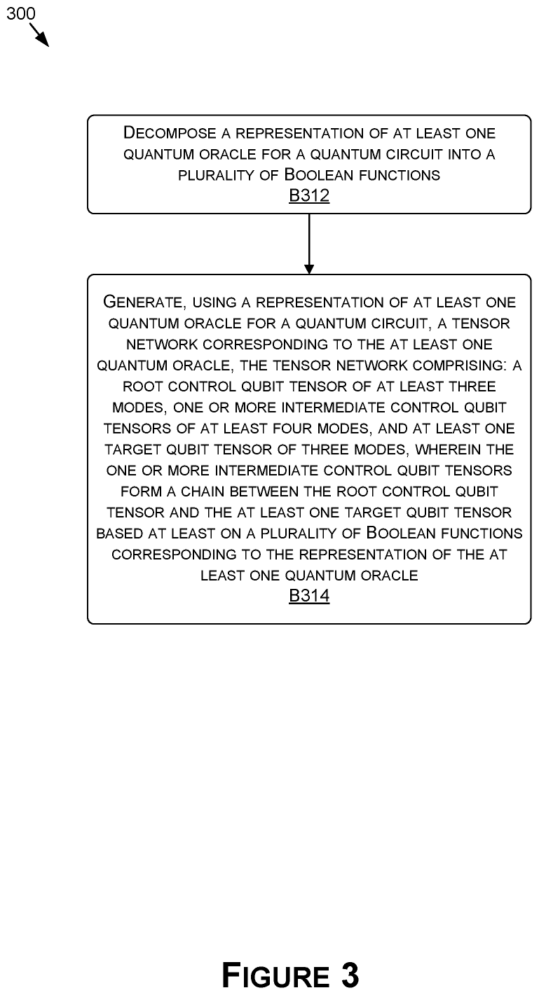

Now referring to FIG. 3, FIG. 3 is a flow diagram showing a method 300 for simulating a quantum circuit using Boolean tensor network representations, in accordance with some embodiments of the present disclosure. The features and elements described herein with respect to the method 300 of FIG. 3 may be used in conjunction with, in combination with, or substituted for elements of, any of the other embodiments discussed herein and vice versa. Further, the functions, structures, and other descriptions of elements for embodiments described in FIG. 3 may apply to like or similarly named or described elements across any of the figures and/or embodiments described herein and vice versa.

Each block of method 300, described herein, comprises a computing process that may be performed using any combination of hardware, firmware, and/or software. For instance, various functions may be carried out by a processor executing instructions stored in memory. The methods may additionally, or alternatively, be embodied as computer-usable instructions stored on computer storage media. The methods may be provided by a standalone application, a service or hosted service (standalone or in combination with another hosted service), or a plug-in to another product, to name a few. In addition, method 300 is described, by way of example, with respect to the example quantum simulation computing platform 120 of FIG. 1. However, these methods may additionally or alternatively be executed by any one system, or any combination of systems, including, but not limited to, those described herein.

In some embodiments, method 300 may generally be directed to generating a tensor network representation of a quantum oracle based at least on a decomposition of a first representation of the quantum oracle into a plurality of two-variable Boolean functions, and simulating at least a portion of the quantum oracle based at least on the tensor network representation of the quantum oracle.

In some embodiments, the method 300, at B312, may include decomposing a representation of at least one quantum oracle for a quantum circuit into a plurality of Boolean functions. In some embodiments, the representation of at least one quantum oracle may be extracted from a representation of a quantum circuit. For example, in some embodiments, a quantum oracle pre-processing engine may include a Boolean oracle extractor 132 and a Boolean tensor network generation engine 136 as shown in the quantum oracle pre-processing engine 130 shown in FIG. 1. The Boolean oracle extractor 132 may receive a representation of a quantum circuit 200 and extract a Boolean logic representation 220 of the quantum oracle that comprises a plurality of Boolean functions 222. In some embodiments, the Boolean oracle extractor 132 may identify from the representation of the quantum circuit 200 a set of Boolean functions corresponding to the quantum oracle that defines a concatenated Boolean function. Boolean oracle extractor 132 may determine one or more concatenated Boolean operation functions from the quantum circuit 200 based at least on an input of one or more identifiers. In some embodiments, an input to the Boolean oracle extractor 132 may include one or more identifiers (e.g., one or more labels included with the quantum computing component 114) that specify which operations of the quantum circuit 200 define a quantum oracle that can be decomposed into a chain of Boolean functions. In some embodiments, the Boolean oracle extractor 132 may apply a classification algorithm to determine which operations of the quantum circuit 200 define a quantum oracle.

In some embodiments, the method 300 may decompose Boolean operators of the Boolean logic representation 220 into a plurality of Boolean functions, OPᵢ. In some embodiments, the operations, OPᵢ, may be individually decomposed from the Boolean logic representation 220 based on the unitary matrix representation for the Boolean logic representation 220. For example, in some embodiments, the Boolean tensor network generation engine 136 may perform a decomposition by matching patterns of 4×4 sub-matrix elements of unitary matrix representations to patterns of predefined Boolean functions using patterns (such as truth tables) stored in a memory of the platform 120 and/or using a matching algorithm. For example, the Boolean tensor network generation engine 136 may iteratively evaluate the unitary matrix of the Boolean logic representation 220 to identify 2×2 and/or 4×4 sub-matrix elements having a pattern that matches a truth table pattern corresponding to a specific Boolean function (such as, but not limited to, AND, OR, XOR, NAND, NOR, and XNOR operators) and accordingly create a chain of intermediate control qubit tensors, each performing a Boolean function identified from the matching. In some embodiments, Boolean tensor network generation engine 136 may individually decompose the plurality of Boolean functions from the Boolean logic representation 220 based at least on a unitary matrix representation of the first tensor network. In some embodiments, Boolean tensor network generation engine 136 may individually decompose the plurality of Boolean functions from the Boolean logic representation 220 based at least on matching patterns of sub-matrix elements of the unitary matrix representation with a predetermined set of matrix patterns associated with Boolean functions.

Referring now to FIG. 3, method 300 at B314 includes generating, using a representation of at least one quantum oracle for a quantum circuit, a tensor network (e.g., an oracle tensor network 230) corresponding to the at least one quantum oracle, the tensor network comprising: a root control qubit tensor of at least three modes, one or more intermediate control qubit tensors of at least four modes, and at least one target qubit tensor of three modes, wherein the one or more intermediate control qubit tensors form a chain between the root control qubit tensor and the at least one target qubit tensor based at least on a plurality of Boolean functions corresponding to the representation of the at least one quantum oracle. The tensor network may comprise a matrix product operator (MPO) tensor network. The at least one target qubit tensor may comprise a single target qubit or a plurality of target qubits. In some embodiments, the second tensor network is generated by a Boolean tensor network generation engine 136. In some embodiments, the Boolean tensor network generation engine 136 processes the set of Boolean functions to generate a tensor network comprising three tensor classes (e.g., the root control qubit tensor of three modes, the one or more intermediate control qubit tensors of four modes, and the at least one target qubit tensor of three modes). The Boolean tensor network generation engine 136 may generate the one or more intermediate control qubit tensors (such as intermediate control qubit tensors 234) with an output mode that outputs a Boolean logic value bonding index generated based at least on an application of a first Boolean function from the plurality of Boolean functions to a control qubit and a previous bonding index. In some embodiments, the Boolean tensor network generation engine 136 may generate an original tensor network representation of the quantum oracle to further include a root control qubit tensor of three modes (such as root control qubit tensor 232) and at least one target qubit tensor of three modes (such as target qubit tensor 236). The one or more four-mode control qubit tensors 234 may form a chain based at least on the plurality of Boolean functions.

In some embodiments, method 300 includes simulating at least a portion of the quantum circuit based at least on the tensor network corresponding to the quantum oracle. In some embodiments, a tensor network simulator (e.g., tensor network simulator 150) may execute quantum circuit simulations based on the tensor network representation 138 derived from the quantum computing component 114 quantum oracle pre-processing engine 130 either with, or without, applying a tensor network contraction. In some embodiments, a simulation result of simulation of the quantum circuit is computed based at least on a simulation result of simulating the quantum oracle based at least on the second representation of the quantum oracle. In some embodiments, a Boolean result of the at least one target qubit tensor from simulation of at least the portion of the quantum oracle may be applied as an input to a quantum algorithm simulation. In some embodiments, the simulation may include operations such as, but not limited to: extracting, from the simulation result, a representation of at least a component of a state vector of the quantum circuit; extracting a representation of at least one component of one or more product states of the quantum circuit; obtaining an expectation value of the quantum circuit; sampling at least one component of one or more product states of a final state; or computing a norm of a final state vector.

In some embodiments, method 300 may further include applying a tensor network contraction based on the tensor network. For example, in some embodiments, the method includes using a tensor network contraction optimizer (such as tensor network contraction optimizer 151) to input the tensor network representation 138 (which incorporates the oracle tensor network 230) and perform a pathfinding algorithm, or other tensor contraction optimization algorithm, to iteratively identify tensors of the tensor network representation 138 that can be contracted together in order to find an optimal contraction order to pair tensors for more efficient execution by the tensor network simulator 150. The Boolean function-based decomposition of the quantum oracle into the original tensor network of simple (e.g., two-variable) Boolean functions provides the tensor network contraction optimizer with greater flexibility in finding an optimal contraction order and avoids the need for the tensor network contraction optimizer to store large intermediate tensors while prioritizing and performing tensor contraction operations.

### Example Computing Device

FIG. 4 is a block diagram of an example computing device(s) 400 suitable for use in implementing some embodiments of the present disclosure. For example, one or more elements of the quantum simulation computing platform 120, such as the quantum oracle pre-processing engine 130 and/or the simulation processing component(s) 140 may be implemented using one or more of computing device(s) 400. Computing device 400 may include an interconnect system 402 that directly or indirectly couples the following devices: memory 404, one or more central processing units (CPUs) 406, one or more graphics processing units (GPUs) 408, one or more quantum processing units (QPUs) 409, a communication interface 410, input/output (I/O) ports 412, input/output components 414, a power supply 416, one or more presentation components 418 (e.g., display(s)), and/or one or more logic units 420. In some embodiments, quantum simulation computing platform 120 and/or simulation processing component(s) 140 are implemented at least in part using one or more of the CPU(s) 406, GPU(s) 408 and/or QPU(s) 409. In at least one embodiment, the computing device(s) 400 may comprise one or more virtual machines (VMs), and/or any of the components thereof may comprise virtual components (e.g., virtual hardware components). For non-limiting examples, one or more of the GPUs 408 may comprise one or more vGPUs, one or more of the CPUs 406 may comprise one or more vCPUs, and/or one or more of the logic units 420 may comprise one or more virtual logic units. As such, a computing device(s) 400 may include discrete components (e.g., a full GPU dedicated to the computing device 400), virtual components (e.g., a portion of a GPU dedicated to the computing device 400), or a combination thereof.

Although the various blocks of FIG. 4 are shown as connected via the interconnect system 402 with lines, this is not intended to be limiting and is for clarity only. For example, in some embodiments, a presentation component 418, such as a display device, may be considered an I/O component 414 (e.g., if the display is a touch screen). As another example, the CPUs 406 and/or GPUs 408 may include memory (e.g., the memory 404 may be representative of a storage device in addition to the memory of the GPUs 408, the CPUs 406, and/or other components). In other words, the computing device of FIG. 4 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 4.

The interconnect system 402 may represent one or more links or busses, such as an address bus, a data bus, a control bus, or a combination thereof. The interconnect system 402 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 406 may be directly connected to the memory 404. Further, the CPU 406 may be directly connected to the GPU 408. Where there is direct, or point-to-point connection between components, the interconnect system 402 may include a PCIe link to carry out the connection. In these examples, a PCI bus need not be included in the computing device 400.

The memory 404 may include any of a variety of computer-readable media. The computer-readable media may be any available media that may be accessed by the computing device 400. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 404 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 400. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 406 may be configured to execute at least some of the computer-readable instructions to control one or more components of the computing device 400 to perform one or more of the methods and/or processes described herein. The CPU(s) 406 may each include one or more cores (e.g., one, two, four, eight, twenty-eight, seventy-two, etc.) that are capable of handling a multitude of software threads simultaneously. The CPU(s) 406 may include any type of processor, and may include different types of processors depending on the type of computing device 400 implemented (e.g., processors with fewer cores for mobile devices and processors with more cores for servers). For example, depending on the type of computing device 400, the processor may be an Advanced RISC Machines (ARM) processor implemented using Reduced Instruction Set Computing (RISC) or an x86 processor implemented using Complex Instruction Set Computing (CISC). The computing device 400 may include one or more CPUs 406 in addition to one or more microprocessors or supplementary co-processors, such as math co-processors.

In addition to, or alternatively from, the CPU(s) 406, the GPU(s) 408 may be configured to execute at least some of the computer-readable instructions to control one or more components of the computing device 400 to perform one or more of the methods and/or processes described herein. One or more of the GPU(s) 408 may be an integrated GPU (e.g., with one or more of the CPU(s) 406 and/or one or more of the GPU(s) 408 may be a discrete GPU. In embodiments, one or more of the GPU(s) 408 may be a coprocessor of one or more of the CPU(s) 406. The GPU(s) 408 may be used by the computing device 400 to render graphics (e.g., 3D graphics) or perform general purpose computations. For example, the GPU(s) 408 may be used for General-Purpose computing on GPUs (GPGPU). The GPU(s) 408 may include hundreds or thousands of cores that are capable of handling hundreds or thousands of software threads simultaneously. The GPU(s) 408 may generate pixel data for output images in response to rendering commands (e.g., rendering commands from the CPU(s) 406 received via a host interface). The GPU(s) 408 may include graphics memory, such as display memory, for storing pixel data or any other suitable data, such as GPGPU data. The display memory may be included as part of the memory 404. The GPU(s) 408 may include two or more GPUs operating in parallel (e.g., via a link). The link may directly connect the GPUs (e.g., using NVLINK) or may connect the GPUs through a switch (e.g., using NVSwitch). When combined together, each GPU 408 may generate pixel data or GPGPU data for different portions of an output or for different outputs (e.g., a first GPU for a first image and a second GPU for a second image). Each GPU may include its own memory, or may share memory with other GPUs.

In addition to, or alternatively from, the CPU(s) 406 and/or the GPU(s) 408, the logic unit(s) 420 may be configured to execute at least some of the computer-readable instructions to control one or more components of the computing device 400 to perform one or more of the methods and/or processes described herein. In embodiments, the CPU(s) 406, the GPU(s) 408, and/or the logic unit(s) 420 may discretely or jointly perform any combination of the methods, processes and/or portions thereof. One or more of the logic units 420 may be part of and/or integrated in one or more of the CPU(s) 406 and/or the GPU(s) 408 and/or one or more of the logic units 420 may be discrete components or otherwise external to the CPU(s) 406 and/or the GPU(s) 408. In embodiments, one or more of the logic units 420 may be a coprocessor of one or more of the CPU(s) 406 and/or one or more of the GPU(s) 408.

Examples of the logic unit(s) 420 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 410 may include one or more receivers, transmitters, and/or transceivers that enable the computing device 400 to communicate with other computing devices via an electronic communication network, included wired and/or wireless communications. The communication interface 410 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 420 and/or communication interface 410 may include one or more data processing units (DPUs) to transmit data received over a network and/or through interconnect system 402 directly to (e.g., a memory of) one or more GPU(s) 408.

The I/O ports 412 may enable the computing device 400 to be logically coupled to other devices including the I/O components 414, the presentation component(s) 418, and/or other components, some of which may be built in to (e.g., integrated in) the computing device 400. Illustrative I/O components 414 include a microphone, mouse, keyboard, joystick, game pad, game controller, satellite dish, scanner, printer, wireless device, etc. The I/O components 414 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 400. The computing device 400 may be include depth cameras, such as stereoscopic camera systems, infrared camera systems, RGB camera systems, touchscreen technology, and combinations of these, for gesture detection and recognition. Additionally or alternatively, the computing device 400 may include accelerometers or gyroscopes (e.g., as part of an inertia measurement unit (IMU)) that enable detection of motion. In some examples, the output of the accelerometers or gyroscopes may be used by the computing device 400 to render immersive augmented reality or virtual reality.

The power supply 416 may include a hard-wired power supply, a battery power supply, or a combination thereof. The power supply 416 may provide power to the computing device 400 to enable the components of the computing device 400 to operate.

The presentation component(s) 418 may include a display (e.g., a monitor, a touch screen, a television screen, a heads-up-display (HUD), other display types, or a combination thereof), speakers, and/or other presentation components. The presentation component(s) 418 may receive data from other components (e.g., the GPU(s) 408, the CPU(s) 406, DPUs, etc.), and output the data (e.g., as an image, video, sound, etc.). In some embodiments, the HMI of user device 116 may be implemented at least in part using the presentation component(s) 418

### Example Data Center

FIG. 5 illustrates an example data center 500 that may be used in at least one embodiments of the present disclosure. For example, one or more elements of the quantum simulation computing platform 120, such as the quantum oracle pre-processing engine 130 and/or the simulation processing component(s) 140 may be implemented using data center 500. The data center 500 may include a data center infrastructure layer 510, a framework layer 520, a software layer 530, and/or an application layer 540.

As shown in FIG. 5, the data center infrastructure layer 510 may include a resource orchestrator 512, grouped computing resources 514, and node computing resources (“node C.R.s”) 516(1)-516(N), where “N” represents any whole, positive integer. In at least one embodiment, node C.R.s 516(1)-516(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 516(1)-516(N) may correspond to a server having one or more of the above-mentioned computing resources. In addition, in some embodiments, the node C.R.s 516(1)-5161(N) may include one or more virtual components, such as vGPUs, vCPUs, and/or the like, and/or one or more of the node C.R.s 516(1)-516(N) may correspond to a virtual machine (VM).

In at least one embodiment, grouped computing resources 514 may include separate groupings of node C.R.s 516 housed within one or more racks (not shown), or many racks housed in data centers at various geographical locations (also not shown). Separate groupings of node C.R.s 516 within grouped computing resources 514 may include grouped compute, network, memory or storage resources that may be configured or allocated to support one or more workloads. In at least one embodiment, several node C.R.s 516 including CPUs, GPUs, DPUs, and/or other processors may be grouped within one or more racks to provide compute resources to support one or more workloads. The one or more racks may include any number of power modules, cooling modules, and/or network switches, in any combination. In some embodiments, quantum simulation computing platform 120 and/or simulation processing component(s) 140 are implemented at least in part using one or more of the node C.R.s 516(1)-516(N).

The resource orchestrator 512 may configure or otherwise control one or more node C.R.s 516(1)-516(N) and/or grouped computing resources 514. In at least one embodiment, resource orchestrator 512 may include a software design infrastructure (SDI) management entity for the data center 500. The resource orchestrator 512 may include hardware, software, or some combination thereof.

In at least one embodiment, as shown in FIG. 5, framework layer 520 may include a job scheduler 528, a configuration manager 534, a resource manager 536, and/or a distributed file system 538. The framework layer 520 may include a framework to support software 532 of software layer 530 and/or one or more application(s) 542 of application layer 540. The software 532 or application(s) 542 may respectively include web-based service software or applications, such as those provided by Amazon Web Services, Google Cloud and Microsoft Azure. The framework layer 520 may be, but is not limited to, a type of free and open-source software web application framework such as Apache Spark™ (hereinafter “Spark”) that may utilize distributed file system 538 for large-scale data processing (e.g., “big data”). In at least one embodiment, job scheduler 528 may include a Spark driver to facilitate scheduling of workloads supported by various layers of data center 500. The configuration manager 534 may be capable of configuring different layers such as software layer 530 and framework layer 520 including Spark and distributed file system 538 for supporting large-scale data processing. The resource manager 536 may be capable of managing clustered or grouped computing resources mapped to or allocated for support of distributed file system 538 and job scheduler 528. In at least one embodiment, clustered or grouped computing resources may include grouped computing resource 514 at data center infrastructure layer 510. The resource manager 536 may coordinate with resource orchestrator 512 to manage these mapped or allocated computing resources.

In at least one embodiment, software 532 included in software layer 530 may include software used by at least portions of node C.R.s 516(1)-516(N), grouped computing resources 514, and/or distributed file system 538 of framework layer 520. One or more types of software may include, but are not limited to, Internet web page search software, e-mail virus scan software, database software, and streaming video content software.

In at least one embodiment, application(s) 542 included in application layer 540 may include one or more types of applications used by at least portions of node C.R.s 516(1)-516(N), grouped computing resources 514, and/or distributed file system 538 of framework layer 520. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 534, resource manager 536, and resource orchestrator 512 may implement any number and type of self-modifying actions based on any amount and type of data acquired in any technically feasible fashion. Self-modifying actions may relieve a data center operator of data center 500 from making possibly bad configuration decisions and possibly avoiding underutilized and/or poor performing portions of a data center.

The data center 500 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 500. In at least one embodiment, trained or deployed machine learning models corresponding to one or more neural networks may be used to infer or predict information using resources described above with respect to the data center 500 by using weight parameters calculated through one or more training techniques, such as but not limited to those described herein.

In at least one embodiment, the data center 500 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 400 of FIG. 4—e.g., each device may include similar components, features, and/or functionality of the computing device(s) 400. In addition, where backend devices (e.g., servers, NAS, etc.) are implemented, the backend devices may be included as part of a data center 500, an example of which is described in more detail herein with respect to FIG. 5.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 400 described herein with respect to FIG. 4. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C. element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might additionally or alternatively be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A processor comprising:
one or more circuits to generate, using a representation of at least one quantum oracle for a quantum circuit, a tensor network corresponding to the at least one quantum oracle, the tensor network comprising:
a root control qubit tensor of at least three modes;
one or more intermediate control qubit tensors of at least four modes, and at least one target qubit tensor of three modes,
wherein the one or more intermediate control qubit tensors form a chain between the root control qubit tensor and the at least one target qubit tensor based at least on a plurality of Boolean functions corresponding to the representation of the at least one quantum oracle.

2. The processor of claim 1, wherein the one or more processing units are to simulate at least a portion of the quantum circuit based at least on the tensor network corresponding to the at least one quantum oracle.

3. The processor of claim 1, wherein the tensor network comprises a matrix product operator (MPO) tensor network.

4. The processor of claim 1, wherein the at least one target qubit tensor comprises a plurality of target qubits.

5. The processor of claim 1, wherein the one or more circuits are further to:
receive as input a representation of a quantum circuit; and
extract the representation of the at least one quantum oracle based at least on the representation of the quantum circuit.

6. The processor of claim 1, wherein the one or more circuits are further to:
determine one or more concatenated Boolean functions from the representation of the at least one quantum oracle based at least on an input of one or more identifiers.

7. The processor of claim 1, wherein the one or more circuits are further to:
individually decompose the plurality of Boolean functions from the representation of at least one quantum oracle based at least on a unitary matrix representation of the first tensor network.

8. The processor of claim 7, wherein the one or more circuits are further to:
individually decompose the plurality of two-variable Boolean functions from the representation of at least one quantum oracle based at least on matching patterns of sub-matrix elements of the unitary matrix representation with a predetermined set of matrix patterns associated with Boolean functions.

9. The processor of claim 7, wherein the one or more circuits are further to:
generate the one or more intermediate control qubit tensors with an output mode that outputs a Boolean logic value bonding index generated based at least on an application of a first Boolean function from the plurality of Boolean functions to a control qubit and a previous bonding index.

10. The processor of claim 1, wherein the one or more circuits are further to:
apply a Boolean result of the at least one target qubit tensor from simulation of the at least the portion of the quantum circuit as an input to a quantum algorithm simulation.

11. The processor of claim 1, wherein the one or more circuits are further to:
simulate a quantum circuit comprising the quantum oracle, based on a tensor network representation of the quantum circuit comprising the tensor network.

12. The processor of claim 1, wherein the one or more circuits are further to perform at least one operation from a group of operations comprising:
extract, from a simulation result, a representation of at least a component of a state vector of the quantum circuit;
extract a representation of at least one component of one or more product states of the quantum circuit;
obtain an expectation value of the quantum circuit;
compute one or more reduced density matrices for a subset of qubits;
sample at least one component of one or more product states of a final state; or
compute a norm of a final state vector.

13. The processor of claim 1, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for generating or presenting at least one of virtual reality content, augmented reality content, or mixed reality content;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center;
a system for performing generative AI operations;
a system implemented at least partially using a language model;
a system implemented at least partially using cloud computing resources;
a system implemented at least partially using quantum computing resources;
a system utilizing a Quantum Processing Unit (QPU);
a system for performing a state preparation;
a system for compiling a quantum circuit;
a system for executing a quantum circuit;
a system for measuring a quantum state; or
a system for measuring a state of a qubit or qubits.

14. A system comprising:
one or more processing units to:
decompose a first representation of a quantum oracle into a plurality of Boolean functions;
generate a second representation of the quantum oracle that includes one or more four-mode control qubit tensors based at least on the plurality of Boolean functions; and
simulate at least a portion of a quantum circuit comprising the quantum oracle based at least on the second representation of the quantum oracle.

15. The system of claim 14, wherein the one or more processing units are further to:
generate the second representation of the quantum oracle that includes a root control qubit tensor of three modes and at least one target qubit tensor of three modes; and
wherein the one or more four-mode control qubit tensors form a chain between the root control qubit tensor and the at least one target qubit tensor based at least on the plurality of Boolean functions.

16. The system of claim 14, wherein the one or more processing units are further to:
individually decompose the plurality of Boolean functions from the first representation based at least on a unitary matrix representation of the first tensor network.

17. The system of claim 16, wherein the one or more processing units are further to:
individually decompose the plurality of Boolean functions from the first representation based on matching patterns of sub-matrix elements of the unitary matrix representation with a predetermined set of matrix patterns associated with Boolean functions.

18. The system of claim 14, wherein the one or more processing units are further to:
apply a tensor network contraction based at least on the second representation of the quantum oracle; and
simulate at least the portion of the quantum oracle based at least on the tensor network contraction of the second representation of the quantum oracle.

19. The system of claim 14, wherein the one or more processing units are further to:
generate the second representation of the quantum oracle that includes a root control qubit tensor of three modes and at least one target qubit tensor of three modes comprising one or more target qubits.

20. The system of claim 14, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for generating or presenting at least one of virtual reality content, augmented reality content, or mixed reality content;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center;
a system for performing generative AI operations;
a system implemented at least partially using a language model;
a system implemented at least partially using cloud computing resources;
a system implemented at least partially using quantum computing resources;
a system utilizing a Quantum Processing Unit (QPU);
a system for performing a state preparation;
a system for compiling a quantum circuit;
a system for executing a quantum circuit;
a system for measuring a quantum state; or
a system for measuring a state of a qubit or qubits.

21. A method comprising:
generating a tensor network representation of a quantum oracle based at least on a decomposition of a first representation of the quantum oracle into a plurality of two-variable Boolean functions and simulating at least a portion of the quantum oracle based at least on the tensor network representation of the quantum oracle.
